(19) United States
(12) Patent Application Publication
(10) Pub. No.: US 2011/0032916 A1
(43) Pub. Date: Feb. 10, 2011

(54) WIRELESS COMMUNICATION APPARATUS AND METHOD USING THE SAME

(75) Inventor: Jia Ching Lee, HSINCHU COUNTY (TW)

Correspondence Address: HAMRE, SCHUMANN, MUELLER & LARSON, P.C., P.O. BOX 2902, MINNEAPOLIS, MN, 55402-0902, US

(73) Assignee: RALINK TECHNOLOGY CORPORATION, HSINCHU COUNTY (TW)

(21) Appl. No.: 12/649,801

(22) Filed: Dec. 30, 2009

Related U.S. Application Data
(60) Provisional application No. 61/231,034, filed on Aug. 4, 2009.

(51) Int. Cl. H04W 4/00; H04B 7/00; H04L 29/02

(52) U.S. Cl. 370/338; 370/310; 370/465

(57) ABSTRACT

The present invention discloses a wireless communication method for transceiving packets in wireless networks. The method comprises the steps of: transmitting a first packet with a first packet format, wherein a header of the first packet with the first packet format comprises information of a first communication duration; and performing a communication procedure during the first communication duration for transmitting at least one second packet with a second format, for receiving at least one third packet with the second format, or for both transmitting the at least one second packet and receiving the at least one third packet.

### BACKGROUND OF THE INVENTION

1. Field of the Invention

The present invention relates to a communication system, and more particularly, to a method and apparatus for wireless communications.

2. Description of the Related Art

Wireless technology is widely used nowadays. A user can send or receive data from a portable device, such as a mobile phone, a personal digital assistant (PDA) or a notebook computer to another portable device or a stationary device via wireless communication. Different standards are established to govern these communications. IEEE 802.11 and Bluetooth (BT) are the most common standards used in portable devices. The IEEE 802.11 standard defines the transmission in a wireless local area network (WLAN), while Bluetooth is usually used for point-to-point transmission within a short distance. A new standard, Bluetooth 3.0 (BT 3.0), is also proposed for a combo device that integrates WLAN and Bluetooth transmission functions into a single device. The combo device is capable of transceiving signals through both WLAN and Bluetooth channels. However, in a wireless communication system comprising a combo transceiver, a WLAN transceiver and a Bluetooth transceiver, the transmission might be affected by interference. FIG. 1 shows a wireless communication system 100 comprising a combo wireless communication device (WLAN/Bluetooth transceiver) 101, a WLAN transceiver 102, and a Bluetooth transceiver 103. For example, in FIG. 2, when the WLAN transceiver 102 listens to a channel and finds no traffic, the WLAN transceiver 102 starts to transmit WLAN signals. For the duration of T₁-T₂, the Bluetooth transceiver of the combo wireless communication device 101 might also start to transmit Bluetooth signals to a Bluetooth transceiver 103. Collision between the WLAN signals and the Bluetooth signals thus occurs. During wireless signal transmission, the Bluetooth signals are interfered by the WLAN signals transmitted by the WLAN transceiver 102. Because the signal strength of the WLAN signals is greater than the signal strength of the Bluetooth signals, the Bluetooth transceiver 103 receives only the WLAN signals, while the Bluetooth signals are perceived by the Bluetooth transceiver 103 as noises. The Bluetooth transceiver 103 cannot distinguish the Bluetooth signals transmitted by the wireless communication system from the WLAN signals. Therefore, a method for operating a combo wireless communication device and preventing collisions between WLAN signals and Bluetooth signals is needed by the market.

### SUMMARY OF THE INVENTION

A method and apparatus for transceiving packets in wireless networks are disclosed. One embodiment of the present invention discloses a wireless communication method for transceiving packets in wireless networks, comprising the steps of: transmitting a first packet with a first packet format, wherein a header of the first packet with the first packet format comprises information of a first communication duration; and performing a communication procedure during the first communication duration for transmitting at least one second packet with a second format, for receiving at least one third packet with the second format or for both transmitting the at least one second packet and receiving the at least one third packet.

Another embodiment of the invention discloses a wireless communication apparatus for transceiving packets in wireless networks comprising a first transceiver, a second transceiver and an estimation unit. The first transceiver is utilized to transmit a first packet with a first packet format or receive a second packet with the first packet format, wherein headers of the first packet and the second packet comprise information of a first communication duration and information of a second communication duration, respectively. The second transceiver is utilized to perform a communication procedure during the first communication duration or the second communication duration, for transmitting the at least one third packet with a second packet format, for receiving at least one fourth packet with the second packet format, or for both transmitting the at least one third packet and receiving the at least one fourth packet. The estimation unit is utilized to estimate a third communication duration, wherein the first communication duration is equal to or greater than the third communication duration. The third communication duration is one of a transmitting duration, a receiving duration and a transceiving duration, wherein the transmitting duration is configured to transmit the at least one third packet, the receiving duration is configured to receive the at least one fourth packet, and the transceiving duration is configured to transmit the at least one third packet and receive the at least one fourth packet.

### BRIEF DESCRIPTION OF THE DRAWINGS

The accompanying drawings illustrate several embodiments of the invention and, together with the description, serve to explain the principles of the invention. Those skilled in the art will recognize that the particular embodiments illustrated in the drawings are merely exemplary, and are not intended to limit the scope of the present invention.

FIG. 1 shows a conventional wireless communication system;

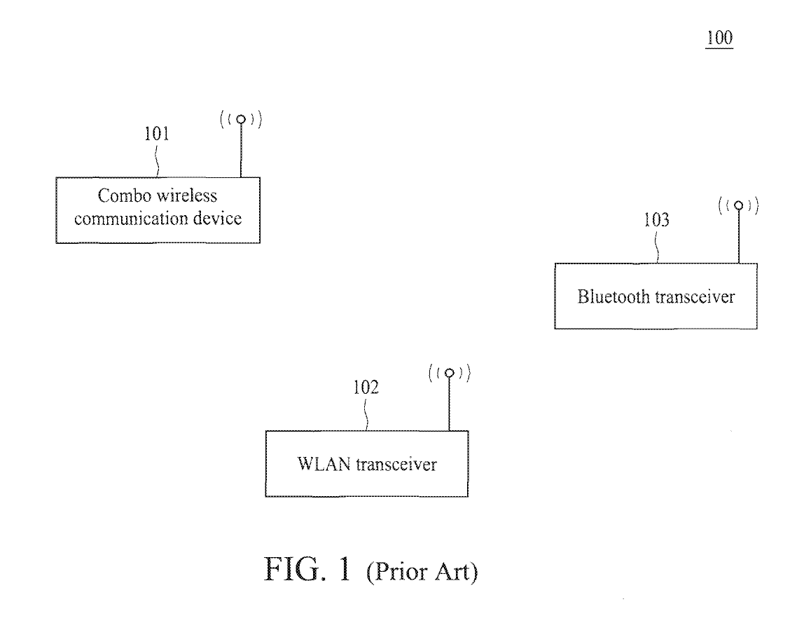

FIG. 2 shows a conventional timing sequence;

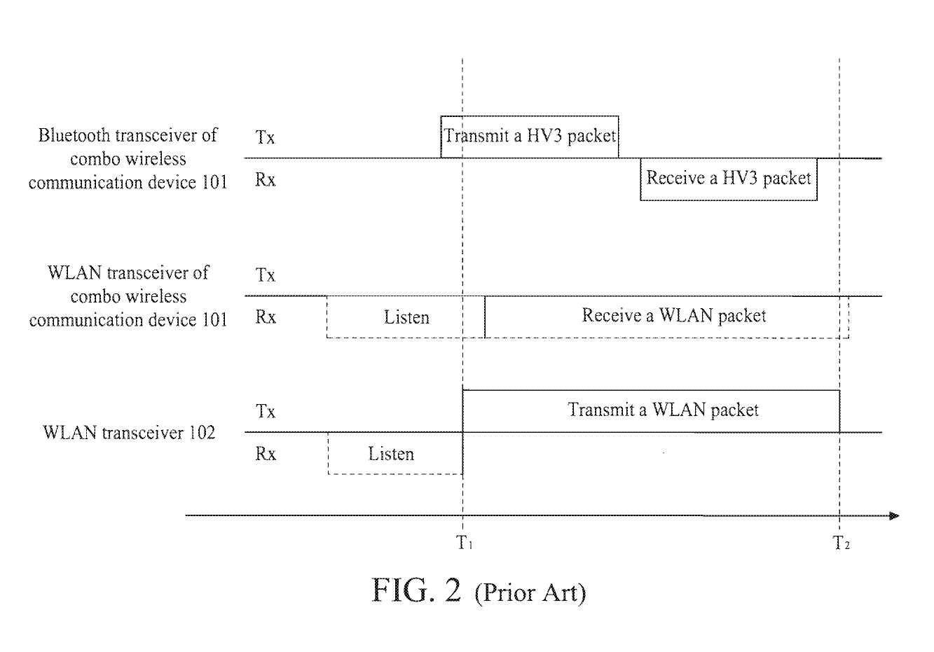

FIG. 3 is a flowchart of a method for transceiving packets in wireless networks in accordance with an exemplary embodiment of the present invention;

FIG. 4 shows a wireless communication system in accordance with an exemplary embodiment of the present invention;

FIG. 5 shows a format of a WLAN CCK packet in accordance with an exemplary embodiment of the present invention;

FIG. 6 shows a timing sequence in accordance with an exemplary embodiment of the present invention; and

FIG. 7 is a block diagram of a wireless communication apparatus in accordance with another exemplary embodiment of the present invention.

### PREFERRED EMBODIMENT OF THE PRESENT INVENTION

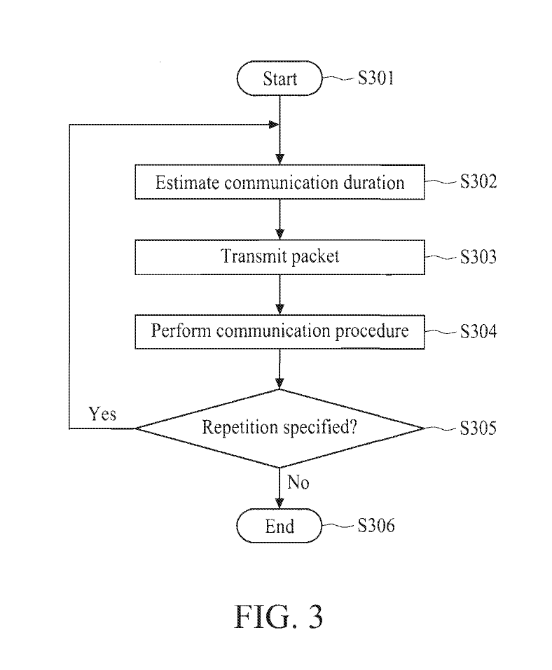

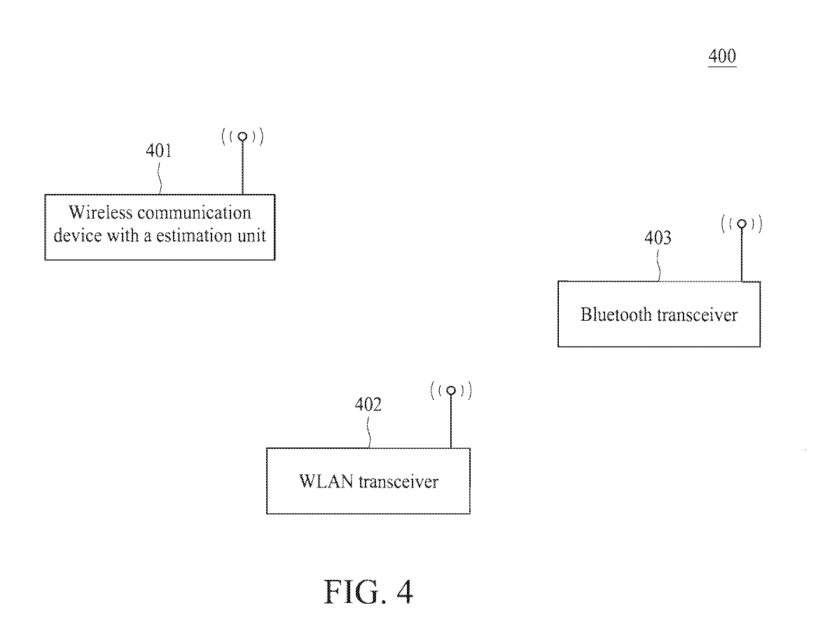

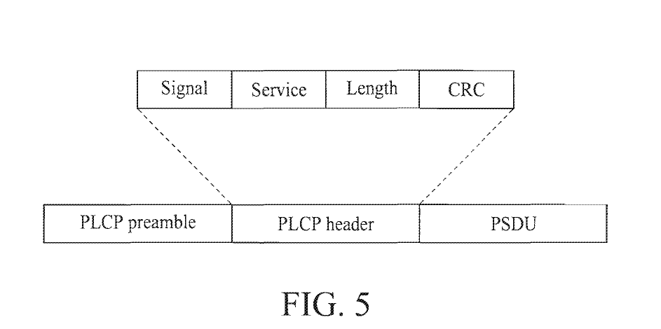

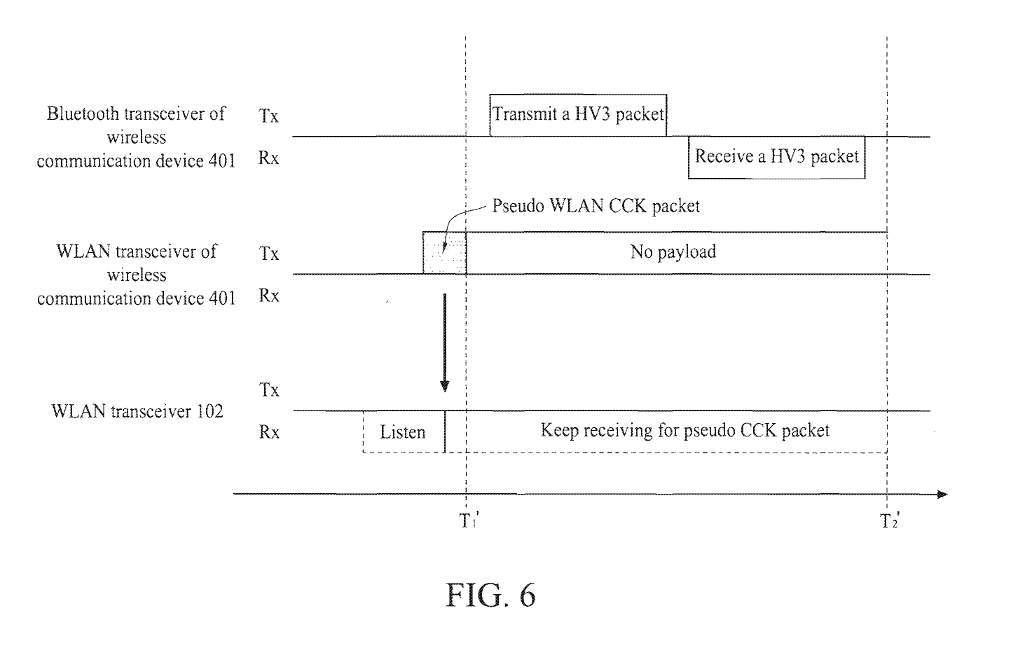

In order to enable those skilled in the art to practice the present invention in accordance with the exemplary embodiment, FIG. 3, FIG. 4, FIG. 5 and FIG. 6 are utilized to describe the procedure of a method for transceiving packets.

FIG. 3 is a flowchart of a method for transceiving packets in wireless networks in accordance with an exemplary embodiment of the present invention. In step S301, the procedure of the embodiment is activated. In step S302, a first communication duration for the Bluetooth transceiver of a wireless communication device 401 with an estimation unit is estimated. The first communication duration is a transmitting duration for transmitting at least one first packet with a Bluetooth packet format, a receiving duration for receiving at least one second packet with the Bluetooth packet format, or a transceiving duration for transmitting the at least one first packet with the Bluetooth packet format and receiving the at least one second packet with the Bluetooth packet format. The first packet or the second packet can be, but are not limited to, a data-medium rate 1 (DM1) packet, a data-high rate 1 (DH1) packet, a data-medium rate 3 (DM3) packet, a data-high rate 3 (DH3) packet, a data-medium rate 5 (DM5) packet, a data-high rate 5 (DH5) packet, an auxiliary 1 (AUX1) packet, a high quality voice 1 (HV1) packet, a high quality voice 2 (HV2) packet, a high quality voice 3 (HV3) packet, a data voice (DV) packet, an identify (ID) packet, a null packet, a poll packet or a frequency hop synchronization (FHS) packet. In the embodiment, a transceiving duration (t=T′₂-T′₁) for transmitting an HV3 packet to a Bluetooth transceiver 403 and receiving another HV3 packet from the Bluetooth transceiver 403 is estimated.

In step S303, a third packet with a wireless local area network (WLAN) packet format is transmitted by the WLAN transceiver of the wireless communication device 401 (see FIG. 4) through a WLAN channel, wherein a header of the third packet comprises information of a second communication duration. The second communication duration can be equal to or greater than the transceiving duration (t=T′₂-T′₁), so as to complete the processes of transmitting the HV3 packet to the Bluetooth transceiver 403 and receiving the other HV3 packet from the Bluetooth transceiver 403. According to an exemplary embodiment, the second communication duration is equal to the transceiving duration (t=T′₂-T′₁). The WLAN transceiver of the wireless communication device 401 is compatible with IEEE 802.11 standards. FIG. 5 shows a format of a WLAN CCK packet in accordance with an exemplary embodiment of the present invention. The content of the WLAN CCK packet comprises a physical layer convergence procedure (PLCP) preamble, a PLCP header and a physical layer service data unit (PSDU). The PLCP header includes a “Signal” field, a “Service” field, a “Length” field and a “Cyclical Redundancy Check (CRC) field, wherein the “Length” field represents the number of microseconds for transmitting the contents of the WLAN CCK packet. A receiver uses this information to determine the end of the WLAN CCK packet. The third packet can be, but is not limited to, a pseudo WLAN complementary code keying (CCK) packet or a pseudo WLAN orthogonal frequency division multiplexing (OFDM) packet. In accordance with one embodiment of the present invention, the pseudo WLAN CCK packet comprises only a PLCP preamble and a PLCP header. That is, the third packet comprises only a PLCP preamble and a PLCP header including the information of the second communication duration which is equal to the transceiving duration (t=T′₂-T′₁). When another WLAN device such as the WLAN transceiver 402 receives the third packet (a pseudo WLAN CCK packet), the WLAN device will not transmit any packet during the duration (t=T′₂-T′₁). In addition, if a WLAN device is not a designated receiver of the third packet, the WLAN device will not transmit any WLAN packet during the duration specified by the PLCP header of the third packet.

In step S304, a communication procedure is performed during the second communication duration by the Bluetooth transceiver of the wireless communication device 401. The communication procedure can be, but is not limited to, a transmitting procedure for transmitting the at least one first packet, a receiving procedure for receiving the at least one second packet, or a transceiving procedure for transmitting the at least one first packet and receiving the at least one second packet. In the embodiment, a transceiving procedure for transmitting the HV3 packet and receiving the other HV3 packet through a Bluetooth channel is performed. As shown in FIG. 6, when the third packet transmitted by the WLAN transceiver of the wireless communication device 401 through the WLAN channel is received by the WLAN transceiver 402, the WLAN transceiver 402 keeps receiving for the third packet until time T′₂. In other words, the WLAN transceiver 402 will not transmit any packet until time T′₂. During the duration (t=T′₂-T′₁), the Bluetooth transceiver of the wireless communication device 401 transmits the HV3 packet and receives the other HV3 packet from the Bluetooth transceiver 403 without being interfered with by other WLAN transceivers including the WLAN transceiver 402. Step 5305 determines whether steps S302-S305 are to be repeated for transceiving packets. If the answer is no, the procedure is ended in step S306.

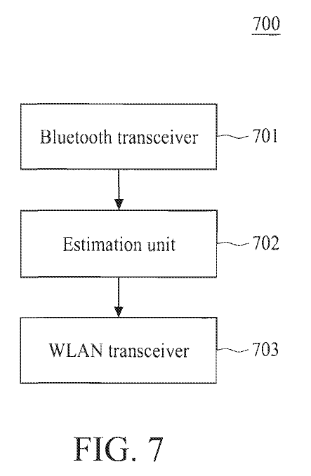

FIG. 7 is a block diagram of a wireless communication apparatus for transceiving packets in wireless networks in accordance with another exemplary embodiment of the present invention. A wireless communication apparatus 700 comprises a Bluetooth transceiver 701, an estimation unit 702 and a WLAN transceiver 703. The estimation unit 702 is configured to estimate a first communication duration, wherein the first communication duration is a transmitting duration for transmitting at least one first packet with a Bluetooth packet format, a receiving duration for receiving at least one second packet with the Bluetooth packet format, or a transceiving duration for transmitting the at least one first packet with the Bluetooth packet format and receiving the at least one second packet with the Bluetooth packet format. The first packet or the second packet can be, but are not limited to, a data-medium rate 1 (DM1) packet, a data-high rate 1 (DH1) packet, a data-medium rate 3 (DM3) packet, a data-high rate 3 (DH3) packet, a data-medium rate 5 (DM5) packet, a data-high rate 5 (DH5) packet, an auxiliary 1 (AUX1) packet, a high quality voice 1 (HV1) packet, a high quality voice 2 (HV2) packet, a high quality voice 3 (HV3) packet, a data voice (DV) packet, an identify (ID) packet, a null packet, a poll packet or a frequency hop synchronization (FHS) packet. The WLAN transceiver 703 is configured to transmit at least one third packet with a WLAN packet format or receive at least one fourth packet with the WLAN packet format, wherein PLCP headers of the at least one third packet and the at least one fourth packet respectively comprise information of the at least one second communication duration and information of at least one third communication duration for transmitting, receiving or transceiving packets by another Bluetooth transceiver (not shown). According to an exemplary embodiment, the second communication duration can be equal to or greater than the first communication duration. The WLAN transceiver 703 complies with IEEE 802.11 standards. The at least one third packet or the at least one fourth packet is a pseudo WLAN CCK packet or a pseudo WLAN OFDM packet. The Bluetooth transceiver 701 is configured to perform a communication procedure during the second communication duration or the third communication duration, wherein the communication procedure is a transmitting procedure for transmitting the at least one first packet, a receiving procedure for receiving the at least one second packet or a transceiving procedure for transmitting the at least one first packet and receiving the at least one second packet.

The above-described embodiments of the present invention are intended to be illustrative only. Numerous alternative embodiments may be devised by persons skilled in the art without departing from the scope of the following claims.

What is claimed is:

1. A wireless communication method, comprising:
transmitting a first packet with a first packet format, wherein a header of the first packet with the first packet format comprises information of a first communication duration; and
performing a communication procedure during the first communication duration for transmitting at least one second packet with a second format, for receiving at least one third packet with the second format, or for both transmitting the at least one second packet and receiving the at least one third packet.

2. The method of claim 1, further comprising the step of:
estimating a second communication duration, wherein the first communication duration is equal to or greater than the second communication duration.

3. The method of claim 1, wherein the second communication duration is one of a transmitting duration, a receiving duration and a transceiving duration, wherein the transmitting duration is configured to transmit the at least one second packet, the receiving duration is configured to receive the at least one third packet, and the transceiving duration is configured to transmit the at least one second packet and receive the at least one third packet.

4. The method of claim 1, wherein the first packet format is a wireless local area network (WLAN) packet format.

5. The method of claim 1, wherein the first packet is a pseudo WLAN complementary code keying (CCK) packet or a pseudo WLAN orthogonal frequency division multiplexing (OFDM) packet.

6. The method of claim 1, wherein the header is a physical layer convergence procedure (PLCP) header.

7. The method of claim 1, wherein the second packet format is a Bluetooth packet format.

8. The method of claim 1, wherein the at least one second packet or the at least one third packet is a data-medium rate 1 (DM1) packet, a data-high rate 1 (DH1) packet, a data-medium rate 3 (DM3) packet, a data-high rate 3 (DH3) packet, a data-medium rate 5 (DM5) packet, a data-high rate 5 (DH5) packet, an auxiliary 1 (AUX1) packet, a high quality voice 1 (HV1) packet, a high quality voice 2 (HV2) packet, a high quality voice 3 (HV3) packet, a data voice (DV) packet, an identify (ID) packet, a null packet, a poll packet or a frequency hop synchronization (FHS) packet.

9. The method of claim 1, wherein the communication procedure is performed by a Bluetooth transceiver of a wireless communication device with an estimation unit.

10. The method of claim 1, wherein the first packet with the first packet format is transmitted by a WLAN transceiver of the wireless communication device.

11. The method of claim 10, wherein the WLAN transceiver complies with IEEE 802.11 standards.

12. A wireless communication apparatus, comprising:
a first transceiver configured to transmit a first packet with a first packet format or receive a second packet with the first packet format, wherein headers of the first packet and the second packet comprise information of a first communication duration and information of a second communication duration, respectively; and
a second transceiver configured to perform a communication procedure during the first communication duration or the second communication duration, for transmitting the at least one third packet with a second packet format, for receiving at least one fourth packet with the second packet format, or for both transmitting the at least one third packet and receiving the at least one fourth packet.

13. The apparatus of claim 12, further comprising:
an estimation unit configured to estimate a third communication duration, wherein the first communication duration is equal to or greater than the third communication duration.

14. The apparatus of claim 13, wherein the third communication duration is one of a transmitting duration, a receiving duration and a transceiving duration, wherein the transmitting duration is configured to transmit the at least one third packet, the receiving duration is configured to receive the at least one fourth packet, and the transceiving duration is configured to transmit the at least one third packet and receive the at least one fourth packet.

15. The apparatus of claim 12, wherein the first transceiver is a wireless local area network (WLAN) transceiver.

16. The apparatus of claim 15, wherein the WLAN transceiver complies with IEEE 802.11 standard.

17. The apparatus of claim 12, wherein the second transceiver is a Bluetooth transceiver.

18. The apparatus of claim 12, wherein the first packet format is a wireless local area network (WLAN) packet format.

19. The apparatus of claim 12, wherein the first packet or the second packet is a pseudo WLAN complementary code keying (CCK) packet or a pseudo WLAN orthogonal frequency division multiplexing (OFDM) packet.

20. The apparatus of claim 12, wherein the headers are physical layer convergence procedure (PLCP) headers.

21. The apparatus of claim 12, wherein the second packet format is a Bluetooth packet format.

22. The apparatus of claim 12, wherein the at least one third packet or the at least one fourth packet is a data-medium rate 1 (DM1) packet, a data-high rate 1 (DH1) packet, a data-medium rate 3 (DM3) packet, a data-high rate 3 (DH3) packet, a data-medium rate 5 (DM5) packet, a data-high rate 5 (DH5) packet, an auxiliary 1 (AUX1) packet, a high quality voice 1 (HV1) packet, a high quality voice 2 (HV2) packet, a high quality voice 3 (HV3) packet, a data voice (DV) packet, an identify (ID) packet, a null packet, a poll packet or a frequency hop synchronization (FHS) packet.
